(19) United States
(12) Patent Application Publication
(10) Pub. No.: US 2014/0053908 A1
(43) Pub. Date: Feb. 27, 2014

(54) THERMOPLASTIC POLYURETHANE MULTILAYER PROTECTIVE LINER

(71) Applicant: E I DU PONT DE NEMOURS AND COMPANY, Wilmington, DE (US)

(72) Inventor: BENJAMIN ANDREW SMILLIE, Kingston (CA)

(73) Assignee: E I DU PONT DE NEMOURS AND COMPANY, Wilmington, DE (US)

(21) Appl. No.: 14/010,906

(22) Filed: Aug. 27, 2013

Related U.S. Application Data
(60) Provisional application No. 61/693,377, filed on Aug. 27, 2012.

(51) Int. Cl. F16L 9/147; F16L 57/00; B32B 27/08

(52) U.S. Cl. CPC F16L 9/147; B32B 27/08; F16L 57/00
USPC 137/1; 428/212; 428/36.7; 138/143

(57) ABSTRACT

Disclosed is a multilayer structure useful for preparing highly abrasion-resistant protective liners, including tubular articles such as multilayer tubes or pipes.

This application claims priority from U.S. Provisional Patent Application Ser. No. 61/693,377, filed Aug. 27, 2012.

### FIELD OF THE INVENTION

The invention relates to a multilayer protective liner comprising a thermoplastic polyurethane wear layer.

### BACKGROUND OF THE INVENTION

Mining operations require the transport of highly abrasive particulate or slurry streams. The recovery of bitumen from oil sands is becoming increasingly important in the energy industry. Processing oil sand includes transporting and conditioning the oil sand as aqueous slurry over kilometer lengths of pipe up to one meter or more in diameter, at average slurry flow velocities from 2 to 6 m/s. Often, metal pipes such as carbon steel or cast iron pipes are used for the transport of these highly abrasive streams of oil sand slurry. They are expensive, heavy and only provide a temporary solution since they are eventually destroyed. To increase their lifetimes, the metal pipes may be rotated 90 degrees on their axes on a regular schedule to provide new transport surfaces. However, because of the pipe weight, this rotation is difficult and ultimately the entire pipe is worn out and must be replaced.

Use of plastic pipes, pipe liners and pipe coatings has been proposed to reduce these shortcomings. U.S. Patent Application Publications 2009/0107572 and 2009/0107553 describe abrasion resistant ionomer lined steel pipes. U.S. Patent Application Publication 2010/0108173 discloses abrasion resistant polyolefin lined steel pipes. References to other plastic pipe liners and methods for lining a pipe with a polymeric liner can be found in those publications.

U.S. Patent Application Publication 2010/0059132 describes abrasion resistant pipe liners comprising an abrasion resistant inner layer and a second structural layer comprising extrudable polymer materials. The abrasion resistant layer can be formed from a material having elastic rubber-like properties or a greater hardness than the material forming the structural layer, such as ultra high molecular weight polyethylene or polyamide.

In some cases, additional materials have been used to adhere polymeric pipe liners to metal pipes. Japanese Patent Application JP2000179752 discloses the use of epoxy primers to adhere ionomer tubes to water service metal pipes. European Patent Application EP 0181233 discloses a method for applying a protective coating to a pipe comprising applying an epoxy coating followed by applying one or more polymeric layers. The methods described therein involve either preheating the pipe prior to coating with epoxy or post-coating heating to cure the epoxy. Heating the pipe to cure the epoxy adds to the complexity and expense to prepare the steel pipe for bonding to the ionomer liner.

U.S. Patent Application Publication 2010/0009086 discloses a rapid-cure epoxy coating system for protecting the exterior of pipes. U.S. Patent Application Publication US2013/0065059A1 describes a method for bonding ionomer compositions to a metal substrate using an epoxy composition.

Because of the extreme conditions that lined pipes experience during hydroslurry operations, good adhesion of the liner to the metal pipe casing is important. It is also important that the liner have sufficient resistance to wear from the abrasive slurries to protect the pipe. Other useful properties include good chemical resistance, high temperature resistance, and low moisture transmittance. It may be difficult to attain all properties desirable for a pipe liner in a single material. Therefore, multilayer structures with layers comprising different materials may be advantageous for a pipe liner. For example, one surface layer of a multilayer structure may provide good adhesion to the metal substrate and a second surface layer may provide good abrasion resistance.

German Patent Application DE19602751A1 describes the use of a co-extruded three-layer film for relining water pipes. The film is described as a polyolefin/tie layer/polyurethane where the tie layer is an olefin-based polymer adhesive containing maleic anhydride, with a Vicat softening point (ASTM D 1525) of below 70° C.

U.S. Patent Application Publication 2005/0189028 describes a process to line steel pipes with a combination of a rubber adhesive layer to bond the liner to the steel pipe and then a two-part cast urethane wear layer that is subsequently cross-linked. The process of assembling the rubber-crosslinked urethane pipe is complicated, requiring a number of priming and curing steps.

### SUMMARY OF THE INVENTION

The invention provides a thermoplastic multilayer structure comprising at least three layers, useful as an abrasion resistant liner for a metal substrate used for hydroslurry transport, wherein

(a) a first surface layer acts as an abrasion resistant wear layer and comprises a soft thermoplastic polyether based urethane composition with melting point in a range from about 120 to about 220° C. and Shore A hardness (ASTM D2240, ISO 868) from 85 to 95, Shore D hardness from 32 to 50; and optionally blended with a surface modifying agent;

(b) a second surface layer acts as an adhesive layer for bonding to a metal substrate or an epoxy treated metal substrate and comprises a thermoplastic ethylene acid copolymer composition, or an ionomer thereof, with melting point in a range from about 60 to about 100° C.;

(c) at least one tie layer positioned in contact with one of the surface layers and in contact with one other layer, comprising a coextrudable tie layer composition, acting to bond the surface layer to the other layer, comprising a polyolefin graft copolymer comprising a trunk polymer comprising polyethylene, polypropylene, styrene-ethylene-butene-styrene triblock copolymer, polybutadiene or a copolymer comprising copolymerized units of ethylene and copolymerized units of vinyl acetate, alkyl acrylate or alkyl methacrylate; wherein the alkyl groups have from 1 to 8 carbon atoms, wherein the trunk polymer is modified by grafting thereto a cyclic anhydride of C₄-C₈ unsaturated acids; and optionally

(d) an interior layer of a material comprising a thermoplastic composition with melting point in a range from about 75 to about 150° C., and moisture vapor permeation value less than 2 g-mil/100 in²-day.

Embodiments of the multilayer structure include those wherein

(b) is a second surface layer comprising an ethylene acid terpolymer comprising an E/X/Y terpolymer wherein E represents copolymerized units of ethylene, X is present in an amount of about 2 to about 30 weight % of the E/X/Y polymer and represents copolymerized units of a C₃₋₈ α,β-ethylenically unsaturated carboxylic acid, preferably acrylic acid or methacrylic acid, and Y is present in from 3 to 45 weight % of the E/X/Y copolymer and represents copolymerized units of a softening comonomer selected from alkyl acrylate or alkyl methacrylate, wherein the alkyl groups have from 1 to 8 carbon atoms, or vinyl acetate; or an ionomer thereof wherein at least a portion of the carboxylic acid groups in the terpolymer are neutralized to salts containing alkali metal cations, alkaline earth metal cations, transition metal cations, or combinations of two or more of these metal cations; and/or

(c) is a tie layer comprising a coextrudable composition comprising a polyolefin graft copolymer comprising a trunk polymer comprising polyethylene, polypropylene, styrene-ethylene-butene-styrene triblock copolymer, polybutadiene or a copolymer comprising copolymerized units of ethylene and copolymerized units of vinyl acetate, alkyl acrylate or alkyl methacrylate; wherein the alkyl groups have from 1 to 8 carbon atoms, wherein the trunk polymer is modified by grafting thereto a cyclic anhydride of C₄-C₈ unsaturated acids;

(d) is (1) an ionomer of an E/W ethylene acid dipolymer wherein E represents copolymerized units of ethylene, W is present in an amount of about 2 to about 30 weight % of the E/W dipolymer and represents copolymerized units of a C₃₋₈ α,β-ethylenically unsaturated carboxylic acid, wherein at least a portion of the carboxylic acid groups in the dipolymer are neutralized to salts containing alkali metal cations, alkaline earth metal cations, transition metal cations, or combinations of two or more of these metal cations; or

(2) a polyethylene homopolymer, polyethylene copolymer, or polypropylene copolymer.

A specific embodiment is a three-layer structure comprising

(a) a first surface layer comprising a thermoplastic polyether based urethane composition with melting point in a range from about 120 to about 220° C. and Shore A hardness (ASTM D2240, ISO 868) from 85 to 95, Shore D hardness from 32 to 50; and optionally blended with a surface modifying agent;

(b) a second surface layer comprising an ethylene acid terpolymer comprising an E/X/Y copolymer wherein E represents copolymerized units of ethylene, X is present in an amount of about 2 to about 30 weight % of the E/X/Y polymer and represents copolymerized units of a C₃₋₈ α,β-ethylenically unsaturated carboxylic acid, preferably acrylic acid or methacrylic acid, and Y is present in from 3 to 45 weight % of the E/X/Y copolymer and represents copolymerized units of a softening comonomer selected from alkyl acrylate or alkyl methacrylate, wherein the alkyl groups have from 1 to 8 carbon atoms, or vinyl acetate; or an ionomer thereof wherein at least a portion of the carboxylic acid groups in the terpolymer are neutralized to salts containing alkali metal cations, alkaline earth metal cations, transition metal cations, or combinations of two or more of these metal cations; and

(c) a tie layer comprising a coextrudable composition comprising a polyolefin graft copolymer comprising a trunk polymer comprising polyethylene, polypropylene, styrene-ethylene-butene-styrene triblock copolymer, polybutadiene or a copolymer comprising copolymerized units of ethylene and copolymerized units of vinyl acetate, alkyl acrylate or alkyl methacrylate; wherein the alkyl groups have from 1 to 8 carbon atoms, wherein the trunk polymer is modified by grafting thereto a cyclic anhydride of C₄-C₈ unsaturated acids.

Another embodiment includes a four-layer structure comprising

(a) a first surface layer comprising a thermoplastic polyether based urethane composition with melting point in a range from about 120 to about 220° C. and Shore A hardness (ASTM D2240, ISO 868) from 85 to 95, Shore D hardness from 32 to 50; and optionally blended with a surface modifying agent;

(b) a second surface layer comprising an ethylene acid terpolymer comprising an E/X/Y copolymer wherein E represents copolymerized units of ethylene, X is present in an amount of about 2 to about 30 weight % of the E/X/Y polymer and represents copolymerized units of a C₃₋₈ α,β-ethylenically unsaturated carboxylic acid, preferably acrylic acid or methacrylic acid, and Y is present in from 3 to 45 weight % of the E/X/Y copolymer and represents copolymerized units of a softening comonomer selected from alkyl acrylate or alkyl methacrylate, wherein the alkyl groups have from 1 to 8 carbon atoms, or vinyl acetate; or an ionomer thereof wherein at least a portion of the carboxylic acid groups in the terpolymer are neutralized to salts containing alkali metal cations, alkaline earth metal cations, transition metal cations, or combinations of two or more of these metal cations; and

(c) a tie layer positioned between the first surface layer and the interior layer comprising a coextrudable composition comprising a polyolefin graft copolymer comprising a trunk polymer comprising polyethylene, polypropylene, styrene-ethylene-butene-styrene triblock copolymer, polybutadiene or a copolymer comprising copolymerized units of ethylene and copolymerized units of vinyl acetate, alkyl acrylate or alkyl methacrylate wherein the alkyl groups have from 1 to 8 carbon atoms, wherein the trunk polymer is modified by grafting thereto a cyclic anhydride of C₄-C₈ unsaturated acids; and

(d) an interior layer comprising an ionomer of an E/W ethylene acid dipolymer wherein E represents copolymerized units of ethylene, W is present in an amount of about 2 to about 30 weight % of the E/W dipolymer and represents copolymerized units of a C₃₋₈ α,β-ethylenically unsaturated carboxylic acid, wherein at least a portion of the carboxylic acid groups in the dipolymer are neutralized to salts containing alkali metal cations, alkaline earth metal cations, transition metal cations, or combinations of two or more of these metal cations.

Another embodiment includes a five-layer structure comprising

(a) a first surface layer comprising a thermoplastic polyether based urethane composition with melting point in a range from about 120 to about 220° C. and Shore A hardness (ASTM D2240, ISO 868) from 85 to 95, Shore D hardness from 32 to 50; and optionally blended with a surface modifying agent;

(b) a second surface layer comprising an ethylene acid terpolymer comprising an E/X/Y copolymer wherein E represents copolymerized units of ethylene, X is present in an amount of about 2 to about 30 weight % of the E/X/Y polymer and represents copolymerized units of a C₃₋₈ α,β-ethylenically unsaturated carboxylic acid, preferably acrylic acid or methacrylic acid, and Y is present in from 3 to 45 weight % of the E/X/Y copolymer and represents copolymerized units of a softening comonomer selected from alkyl acrylate or alkyl methacrylate, wherein the alkyl groups have from 1 to 8 carbon atoms, or vinyl acetate; or an ionomer thereof wherein at least a portion of the carboxylic acid groups in the terpolymer are neutralized to salts containing alkali metal cations, alkaline earth metal cations, transition metal cations, or combinations of two or more of these metal cations;

(c)(1) a first tie layer in contact with the first surface layer and the interior layer comprising a coextrudable composition comprising a polyolefin graft copolymer comprising a trunk polymer comprising polyethylene, polypropylene, styrene-ethylene-butene-styrene triblock copolymer, polybutadiene or a copolymer comprising copolymerized units of ethylene and copolymerized units of vinyl acetate, alkyl acrylate or alkyl methacrylate; wherein the alkyl groups have from 1 to 8 carbon atoms, wherein the trunk polymer is modified by grafting thereto a cyclic anhydride of C₄-C₈ unsaturated acids; and

(2) a second tie layer in contact with the second surface layer and the interior layer comprising a coextrudable composition comprising a polyolefin graft copolymer comprising a trunk polymer comprising polyethylene, polypropylene, styrene-ethylene-butene-styrene triblock copolymer, polybutadiene or a copolymer comprising copolymerized units of ethylene and copolymerized units of vinyl acetate, alkyl acrylate or alkyl methacrylate; wherein the alkyl groups have from 1 to 8 carbon atoms, wherein the trunk polymer is modified by grafting thereto a cyclic anhydride of C₄-C₈ unsaturated acids; wherein the first and second tie layer compositions may be the same or different; and

(d) an interior layer comprising a polyethylene homopolymer, polyethylene copolymer, or polypropylene copolymer.

The invention also provides a method for protecting a metal pipe from abrasion during transport of a slurry comprising liquid and abrasive material through the pipe, the method comprising

(a) preparing a multilayer structure as described above;

(b) inserting the multilayer structure inside a pipe;

(c) adhering the multilayer structure to the inside of the pipe to prepare a lined pipe;

(d) installing the lined pipe into a pipeline for transporting a slurry comprising liquid and abrasive material; and

(e) transporting the slurry through the pipeline; preferably wherein the wear rate of the lined pipe is less than the wear rate of a non-lined pipe.

Corrosion resistance of the pipe is also improved by the use of the liners described herein.

Preferably, the inside of the metal pipe is treated with an epoxy primer to provide an epoxy-primed metal pipe prior to inserting the multilayer structure into the pipe.

### DETAILED DESCRIPTION OF THE INVENTION

All publications, patent applications, patents, and other references mentioned herein are incorporated by reference in their entirety.

Although methods and materials similar or equivalent to those described herein can be used in the practice or testing of the present invention, suitable methods and materials are described herein.

Unless stated otherwise, all percentages, parts, ratios, etc., are by weight. When an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range. When the term “about” is used in describing a value or an end-point of a range, the disclosure includes the specific value or end-point referred to.

As used herein, the terms “comprises,” “comprising,” “includes,” “including,” “containing,” “characterized by,” “has,” “having” or any other variation thereof, are intended to cover a non-exclusive inclusion. The transitional phrase “consisting of” excludes any element, step, or ingredient not specified in the claim, closing the claim to the inclusion of materials other than those recited except for impurities ordinarily associated therewith. The transitional phrase “consisting essentially of” limits the scope of a claim to the specified materials or steps and those that do not materially affect the basic and novel characteristic(s) of the claimed invention. A ‘consisting essentially of’ claim occupies a middle ground between closed claims that are written in a ‘consisting of’ format and fully open claims that are drafted in a ‘comprising’ format.

Where applicants have defined an invention or a portion thereof with an open-ended term such as “comprising,” the description is interpreted to also describe such an invention using the terms “consisting essentially of” or “consisting of.”

Use of “a” or “an” are employed to describe elements and components of the invention. This is done merely for convenience and to give a general sense of the invention. This description includes one or at least one and the singular also includes the plural unless it is obvious that it is meant otherwise.

In describing certain polymers it is to be understood that sometimes applicants are referring to the polymers by the monomers used to make them or the amounts of the monomers used to make them. While such a description may not include the specific nomenclature used to describe the final polymer or may not contain product-by-process terminology, any such reference to monomers and amounts is to be interpreted to mean that the polymer is made from those monomers or that amount of the monomers, and the corresponding polymers and compositions thereof.

The materials, methods, and examples herein are illustrative only and, except as specifically stated, are not intended to be limiting.

As used herein, a “multilayer structure” comprises layers of materials wherein all layers in that structure are bonded or adhered to the layers they are in contact with. A multilayer ionomer structure, such as a sheet or tube, has at least one surface layer that comprises an ionomer composition. As used herein, when a multilayer structure is in tubular form, the “outermost” layer is the surface layer facing the outside of the tube, and the “innermost” layer is a surface layer facing the inside of the tube. “Interior” layers are not surface layers. As used herein for multilayer structures, “adhesive” and “adhesive layer” refer to compositions and layers that are in contact with the metal substrate or to an epoxy composition used to adhere the multilayer structure to the metal. The term “wear layer” refers to the layer that is farthest from the metal substrate and functions as an abrasion resistant surface protecting the metal from abrasion. The term “tie layer” refers to a layer that facilitates adherence between two other layers in a multilayer structure.

As used herein, “ambient temperature” means that no heating or cooling is applied to the coated substrate beyond what is prevailing in the environment around the coated substrate. The temperature may be from about 0° C. to about 40° C., preferably from about 20° C. to about 30° C.

For low wear protective coatings, thermoset epoxy or urethane coatings have been applied at less than 500 μm thickness, for example Corlar® from E. I. du Pont de Nemours, Wilmington, Del. (DuPont). The two part epoxies can be painted onto a steel surface by spray, roll or dip coatings. Two part epoxy coatings are also available as fine powders (Napgard® from DuPont) that can be applied by fusion bonding (dip coating of the hot part in a fluidized bed or electrostatic spray of the powder onto the steel). DuPont also has a line of thermoplastic polymer powder coatings under the Abcite® brand include zinc ionomers and acid copolymer resins that can be applied by fusion bonding.

Some applications need better wear and/or corrosion resistance than can be provided by fused powder or paint coatings of the pipe surface. Such thin coatings do not provide sufficient abrasion resistance in applications where metal surfaces are exposed to highly abrasive materials for extended periods of time.

The compositions and multilayer structures described herein can be used to provide metal protected against abrasion by long lifetime, highly abrasion-resistant liners. Applications include lined pipes for a wide variety of mining and other transportation uses over a wide range of environmental conditions. High burst strength may be another attribute of the lined pipes.

We have found that “soft” thermoplastic materials with Shore A hardness in the range from 85 to 95 and Shore D from 32 to 50 are preferred materials for resistance to the abrasive action of sand water slurries.

Excellent adhesion of the liner is also important for such pipe liners. A useful method to bond the thick-walled tubular liner to the prepared metal pipe substrate involves heating the liner to metal interface (by applying heat to the exterior of the metal pipe at a temperature less than 160° C.) while applying pressure to the inside of the liner to expand the liner so that it comes into intimate contact with the interior inside surface of the epoxy primed metal pipe and subsequently thermally activates the bond between liner and metal substrate. Bonding temperatures above 160° C. are not desirable because the thermoplastic liner tends to flow or droop under the effect of gravity at higher bonding temperatures. For high speed slurry flow, waves or a rough inside surface on the lined metal pipe can result in flow irregularities that can promote localized high wear rates. Preferred adhesives include low melting ethylene terpolymers containing acrylic acid or methacrylic acid functionality, and ionomers thereof. Low melting temperature is preferred because less heat is required to activate the bond between adhesive and metal substrate. Minimizing the heat required to activate the bond will minimize energy consumption and reduce the bonding cycle time. Minimizing the melting points of the materials comprising the thick walled multilayer structure will also reduce energy that must be added to the liner before the liner will expand under pressure to come into intimate contact with the interior surface of the pipe wall. The multilayer structure will resist abrasion, will have a smooth inside surface and remain well adhered to the metal substrate with surface and core layers having these characteristics.

For hydroslurry applications where water is the means of fluidizing the particulate, chemical resistance, measured by a test like the Standard Test Method for Environmental Stress-Cracking of Ethylene Plastics ASTM test procedure D1693, to water is of particular importance. Chemical resistance to other components, for example salt solutions (sodium chloride, potassium or calcium chloride) or hydrocarbons (gasoline) of the slurry can be determined by ASTM D1693.

An alternative method to identify chemical resistance is to immerse the selected polymer in the solvent or solution of interest and measure the weight gain. Significant weight gain after a period of exposure indicate the solution is soluble in the polymer which could lead to undesirable effects like swelling of the polymer, plasticization (softening) of the polymer and potential extraction of the low molecular portion of the polymer by the solution. ASTM procedure D570 outlines protocols that can be used to assess the water absorption of a polymer. This test can be modified to consider other solvents besides water, such as hydrocarbons including naphtha.

A good barrier to water permeation may be useful to protect the metal pipe from corrosion and prevent delamination of the liner from the pipe caused by water infiltration. Low water permeability may be most important in the first surface layer and/or interior layers. Water permeation may be assessed using ASTM F1249 Water Vapor Transmission Rate Through Plastic Film and Sheeting Using a Modulated Infrared Sensor. Normal conditions for this test are to operate at 38° C. with 100% relative humidity on one side of the test film and dry on the other side. In this test, 2 g·mil/(100 in²·day) is equivalent to 31 g·25 μm/m²·day.

Embodiments of the multilayer abrasion resistant structure include a first soft surface layer (the innermost layer of a tubular pipe liner) comprising a soft thermoplastic composition and a second surface layer (the outermost layer of a tubular pipe liner) comprising a low melting ionomer of an E/X/Y terpolymer described below.

The soft thermoplastic composition in the first surface layer, the abrasion resistant wear layer of the liner (innermost layer of the pipe liner) has a melting point from about 120 to about 220° C., Shore A hardness (ASTM D2240, ISO 868) from 85 to 95, Shore D hardness from 32 to 50; and optionally blended with a surface modifying agent. The soft thermoplastic composition of this layer may have a flexural modulus determined at 21° C. according to ASTM D790 of less than or equal to 120 MPa, preferably from 25 to 120 MPa.

A material useful in the first surface layer comprises a polyether-based thermoplastic urethane. On a molecular basis, thermoplastic urethane elastomers may be described as linear block copolymers of the AB type. One block of the polymer chain consists of a relatively long, flexible polyester or polyether diol in the typical number-average molecular weight range of 1000 to 3000. These amorphous polyol blocks are usually termed the soft segments since they impart the elastomeric character to the polymer. Polyether diol soft segments are preferred over polyester diol soft segments because the polymer made with the polyether diol should have better resistance to hydrolysis. The second block of the copolymer is commonly referred to as the hard segment and is formed by the reaction of aromatic diisocyanates with low molecular weight diol or triol chain extenders. Due to the polar nature of the urethane groups in the hard segments and their ability to form hydrogen bonds, these hard segments are capable of intermolecular associations and possible domain segregation. The thermally reversible network structure of these copolymers provides for the elastomeric or apparent crosslinked nature of these polymers.

The hardness of the thermoplastic urethane can be adjusted by adjusting the hard segment to soft segment ratio, increasing the length of the soft segment (molecular weight of the polyether), and the type of hard segment. For example, MDI-based thermoplastic urethanes are stiffer than equivalent TDI-based urethanes.

A preferred polyether-based thermoplastic urethane wear layer has a Shore D hardness (ASTM D2240, ISO 868) from about 32 to about 50 and a flexural modulus from about 90 to about 120 MPa and a melting point from about 160 to about 200° C.

The first layer material may also be blended with surface modifying agents such as ultra-high molecular weight siloxane polymers.

Ionomers are useful in the second surface layer and interior layers. The terms “thermoplastic ionomer polymer” and “ionomer”, and similar terms used herein, refer to a thermoplastic ionomer made from a parent acid copolymer comprising, consisting essentially of, or prepared from copolymerized units of an α-olefin, preferably ethylene, copolymerized units of an α,β-ethylenically unsaturated carboxylic acid, and optionally copolymerized units of a softening comonomer. “Softening” means that the polymer is made less crystalline. Ionomers comprise such acid copolymers wherein at least a portion of the carboxylic acids are neutralized to provide carboxylate salts with a metal ion.

The acid copolymers used to make the ionomer compositions described herein are preferably random acid copolymers. In random copolymers, at least some of the atoms comprising the original monomers are copolymerized as part of the polymer backbone or chain.

Acid copolymers may be described as E/X/Y copolymers where E represents copolymerized units of ethylene, X represents copolymerized units of a C₃₋₈ α,β-ethylenically unsaturated carboxylic acid, preferably acrylic acid or methacrylic acid, and Y represents copolymerized units of a softening comonomer selected from alkyl acrylate or alkyl methacrylate, wherein the alkyl groups have from 1 to 8 carbon atoms, or vinyl acetate. X is present in an amount of about 2 to about 30 (or about 2 to 25, or about 2 to 20, or about 5 to 25) weight % of the E/X/Y polymer, and Y is present in from 0 to 45 weight % of the E/X/Y copolymer.

E/X/Y terpolymers may be useful in the adhesive layer (the second surface layer or the outermost layer in a tubular pipe liner) in either nonionized form or as the base resin of an ionomer. Preferably such terpolymers are used as the precursor polymers for ionomers used in the adhesive layer of the multilayer structure. Included are E/X/Y terpolymers in which X represents copolymerized units of methacrylic acid in an amount of about 2 to about 30 (or about 2 to 25, or about 2 to 20, or about 5 to 25) weight % of the E/X/Y terpolymer and Y represents copolymerized units of an alkyl methacrylate or preferably an alkyl acrylate in an amount from 3 to 45 weight % of the E/X/Y terpolymer (such as from a lower limit of 3 or 5 or preferably 10, to an upper limit of 25, 30 or 45). These terpolymers include without limitation ethylene/methacrylic acid/methyl acrylate, ethylene/methacrylic acid/ethyl acrylate, and ethylene/methacrylic acid/iso-butyl acrylate terpolymers, and preferably ethylene/methacrylic acid/n-butyl acrylate terpolymers. A preferred E/X/Y terpolymer is one wherein X is methacrylic acid, present in an amount from 5 to 20 weight % of the E/X/Y terpolymer and Y is butyl acrylate, present in an amount from 10 to 30 weight % of the E/X/Y terpolymer.

Similarly, terpolymers may include copolymerized units of acrylic acid in about 2 to about 30 (or about 2 to 25 or about 2 to 20, or about 5 to 25) weight % of the E/X/Y polymer, and copolymerized units of alkyl methacrylate or alkyl acrylate in an amount from 3 to 45 (such as from a lower limit of 3 or 5 or preferably 10, to an upper limit of 25, 30 or 45) weight % of the E/X/Y terpolymer.

Of note are E/X/Y terpolymers, wherein X (e.g. acrylic acid or preferably methacrylic acid) is present in an amount from 5 to 20 weight % of the copolymer and Y (e.g. alkyl acrylate such as butyl acrylate) is present in an amount from 10 to 30 weight % of the copolymer. These terpolymers may be useful in the second surface layer (i.e. the adhesive layer) in nonionized form or as ionomers.

A specific example is an E/X/Y terpolymer comprising 10 weight % methacrylic acid and 10 weight % n-butyl acrylate based on the total weight of the parent acid terpolymer, the remainder ethylene, with MI of about 10 g/10 min. This terpolymer may be useful in the second surface layer in nonionized form. Another specific example is an E/X/Y terpolymer comprising containing 9 weight % methacrylic acid and 23.5 weight % n-butyl acrylate based on the total weight of the parent acid terpolymer, the remainder ethylene. An ionomer prepared from this terpolymer may be useful in the second surface layer.

Also of note are dipolymers, copolymers consisting essentially of copolymerized units of ethylene and copolymerized units of C₃₋₈ α,β-ethylenically unsaturated carboxylic acid, preferably acrylic acid or methacrylic acid, and 0% of additional softening comonomer. Such E/W dipolymers include those wherein W is present in an amount of 5 or 10 to 25 weight % of the dipolymer, including without limitation ethylene/acrylic acid dipolymers or ethylene/methacrylic acid dipolymers, and are preferably used for ionomers in an interior core layer of the multilayer structure.

The parent acid copolymers may be polymerized as disclosed in U.S. Pat. Nos. 3,404,134; 5,028,674; 6,500,888; and 6,518,365. They may be neutralized as disclosed in U.S. Pat. Nos. 3,264,272 and 3,404,134 to salts comprising metal ions. The ionomers may be neutralized to any level that does not result in an intractable (not melt processible) polymer without useful physical properties. The ionomers are neutralized so that from about 5 to about 90%, or preferably from about 15 to about 90%, more preferably about 40 to about 75% of the acid moieties of the acid copolymer are neutralized to form carboxylate groups, based on the total carboxylic acid content of the parent acid copolymers as calculated for the non-neutralized parent acid copolymers.

Preferred counterions for the carboxylate groups include alkali metal cations, alkaline earth metal cations, transition metal cations, and combinations of two or more of these metal cations. The metal ions may be monovalent, divalent, trivalent, multivalent, or mixtures thereof. When the metallic ion is multivalent, complexing agents such as stearate, oleate, salicylate, and phenolate radicals may be included, as disclosed in U.S. Pat. No. 3,404,134. The metallic ions are preferably monovalent or divalent metallic ions.

Preferably, cations useful in the ionomers include lithium, sodium, potassium, magnesium, calcium, or zinc, or combinations of two or more of these cations. More preferably, the metallic ions are selected from the group consisting of sodium, lithium, magnesium, zinc and mixtures thereof, yet more preferably, sodium, zinc and mixtures thereof. Most preferably, the metallic ions are zinc.

An ionomer composition used as the adhesive layer in the multilayer liner structure has a melting point of about 60 to about 220° C., preferably about 60 to about 80° C., more preferably from about 65 to about 75° C. Preferably, it also has flexural modulus determined at 21° C. according to ASTM D790 of less than or equal to 90 MPa and Shore D hardness (ASTM D2240, ISO 868) from about 30 to about 50.

The multilayer structure may also comprise at least one tie layer comprising a coextrudable tie layer composition comprising a polyolefin graft copolymer comprising a trunk polymer comprising polyethylene, polypropylene, styrene-ethylene-butene-styrene triblock copolymer, polybutadiene or a copolymer comprising copolymerized units of ethylene and copolymerized units of vinyl acetate, alkyl acrylate or alkyl methacrylate; wherein the alkyl groups have from 1 to 8 carbon atoms, wherein the trunk polymer is modified by grafting thereto a cyclic anhydride of C₄-C₈ unsaturated acids.

Graft copolymers are synthesized by appending or “grafting” a moiety as a pendant group on an already-formed polymer chain. The grafted comonomer is attached to non-terminal repeat units of an existing polymer chain in a step subsequent to formation of the polymer chain, often by a free radical reaction. In a graft copolymer, none of the atoms of the grafted group are incorporated into the backbone of the polymer chain. The term “trunk polymer” as employed herein includes polyolefins such as polyethylene, ethylene propylene copolymers, and polypropylene or the polymerization product of ethylene and at least one additional polymerizable monomer such as vinyl acetate, alkyl acrylate, alkyl methacrylate, etc. that are polymerized or copolymerized and subsequently grafted with an additional comonomer to provide a graft copolymer.

A preferred anhydride is maleic anhydride. These maleic anhydride-grafted polymers (maleated polymers) are polymeric materials in which maleic anhydride is reacted with an existing polymer, often under free-radical conditions, to form anhydride groups appended to the polymer chain. They include maleated polyethylene, maleated polypropylene, maleated ethylene vinyl acetate copolymers, maleated ethylene methyl acrylate copolymers, maleated metallocene polyethylene, maleated ethylene propylene copolymers, maleated styrene-ethylene-butene-styrene triblock copolymer, and maleated polybutadiene and maleated ethylene propylene diene copolymers.

The trunk polymers may be synthesized and subsequently grafted with maleic anhydride according to well-known procedures. Such graft copolymers are also commercially available from DuPont under the tradename Fusabond®.

A notable maleated copolymer useful as tie layer in the multilayer structure is a maleic anhydride modified ethylene alkyl acrylate graft copolymer.

The tie layer may comprise a blend of polyolefin graft copolymer and a terpolymer comprising copolymerized units of ethylene, acrylic acid or methacrylic acid, and an alkyl acrylate or alkyl methacrylate, wherein the alkyl group comprises 1 to 4 carbon atoms. An example blend includes one wherein the polyolefin graft copolymer comprises a trunk polymer comprising copolymerized units of ethylene and copolymerized units of vinyl acetate, alkyl acrylate or alkyl methacrylate wherein the alkyl groups have from 1 to 8 carbon atoms, wherein the trunk polymer is modified by grafting thereto maleic anhydride and the terpolymer comprises copolymerized units of ethylene, methacrylic acid, and butyl acrylate.

The multilayer structure may have an interior core layer in addition to the surface layers. The interior layer provides the high thermal resistance to the pipe required by many demanding uses. Polymers useful in the interior layer have melting points in a range from about 75 to about 150° C., preferably about 80° C. to 120° C. or higher, most preferably about 85° C. or higher. The interior layer may also serve as a moisture barrier, and the interior layer composition has a moisture vapor permeation value less than 2 g·mil/100 in²·day, preferably below 1.5 g·mil/100 in²·day, or lower.

For an E/W ionomer used in an interior layer of the multilayer liner structure, the composition has a flexural modulus determined at 21° C. according to ASTM D790 of greater than 80 MPa, preferably greater than 200 MPA. Preferably the ionomer has a melting point in a range from about 75 to about 150° C., preferably about 80° C. to 120° C. or higher, most preferably about 85° C. or higher. The ionomer layer provides the high thermal resistance to the pipe required by many demanding uses. To serve as a moisture barrier, the composition has a moisture vapor permeation value less than 2 g·mil/100·in²·day, preferably below 1.5 g·mil/100 in²·day, or lower.

A notable ionomer used in an interior layer consists essentially of an E/W dipolymer containing 15 weight % methacrylic acid based on the total weight of the parent acid dipolymer, the remainder ethylene, wherein at least a portion of the carboxylic acid groups are neutralized to salts of zinc ions.

Suitable ionomers for the adhesive or interior layers are available commercially from DuPont under the Surlyn® tradename.

The interior layer of the multilayer structure may alternatively comprise polyethylene homopolymers, polyethylene copolymers, or polypropylene copolymers. These polymers also have melting points in a range from about 75 to about 150° C., preferably about 80° C. to 120° C. or higher, most preferably about 85° C. or higher moisture vapor permeation values of less than 2 g·mil/100 in²·day, preferably below 1.5 g·mil/100 in²·day, or lower.

Polyethylene homopolymers or polyethylene copolymers comprise units derived from ethylene as the major portion or percentage by weight of the copolymer, such as greater than about 70 weight %, or greater than about 80 weight % or more of the copolymer. Examples of polyethylene copolymers are copolymers of ethylene and alpha-olefins, including copolymers with propylene and other alpha-olefins, wherein copolymerized units of ethylene comprise the major portion of the copolymer.

Suitable polyethylene homopolymers and polyethylene copolymers include linear polyethylenes such as high density polyethylene (HDPE), linear low density polyethylene (LLDPE), very low or ultralow density polyethylenes (VLDPE or ULDPE), branched polyethylenes such as low density polyethylene (LDPE), and copolymers of ethylene and alpha-olefin monomers prepared in the presence of metallocene catalysts, single site catalysts or constrained geometry catalysts (herein referred to as metallocene polyethylenes, or MPE). The densities of PE suitable for use in the composition range from about 0.865 g/cc to about 0.970 g/cc.

Polyethylene homopolymers and copolymers may be prepared by a variety of methods. Examples of such processes include, but are not limited to, the well-known Ziegler-Natta catalyst polymerization process (see for example U.S. Pat. Nos. 4,076,698 and 3,645,992), metallocene catalyzed polymerization, VERSIPOL® single-site catalyst polymerization and free radical polymerization. The term metallocene catalyzed polymerization includes polymerization processes that involve the use of metallocene catalysts as well as those processes that involve use of constrained geometry and single-site catalysts. Polymerization may be conducted as a solution-phase process, a gas phase-process and the like. Polyethylenes used in the compositions described herein may be obtained from recycled material.

Examples of linear polyethylenes include ethylene copolymers having copolymerized units of alpha-olefin comonomers such as butene, hexene or octene. Suitable alpha-olefins may be selected from the group consisting of alpha-olefins having at least three carbon atoms, preferably from 3 to 20 carbon atoms. These comonomers may be present as copolymerized units in an amount up to about 20 weight % or 30 weight % of the copolymer. Preferred alpha-olefins include propylene, 1-butene, 1-hexene, 4-methyl-1-pentene, 1-octene, 1-decene, 1-tetradecene and 1-octadecene. Copolymers may be obtained by polymerization of ethylene with two or more alpha-olefins, preferably including propylene, 1-butene, 1-octene and 4-methyl-1-pentene.

Also contemplated for use as the polyethylene component are blends of two or more of these ethylene alpha-olefin copolymers as well as mixtures of an ethylene homopolymer and one of the suitable ethylene alpha-olefin copolymers.

Polypropylene copolymers suitable for use as the polyolefin component of the multilayer structure include random copolymers, block copolymers and higher order copolymers, such as terpolymers of propylene. Random copolymers, also known as statistical copolymers, are polymers in which the propylene and the comonomer(s) are randomly distributed throughout the polymeric chain in ratios corresponding to the feed ratio of the propylene to the comonomer(s). Block copolymers are made up of chain segments consisting of propylene homopolymer and of chain segments consisting of, for example, random copolymers of propylene and ethylene. Copolymers of propylene include copolymers of propylene with other olefins such as 1-butene, 2-butene and the various pentene isomers, etc. and preferably copolymers of propylene with ethylene, wherein units derived from propylene comprise the major portion or percentage by weight of the copolymer.

Polypropylene random copolymers can be manufactured by any known process. For example, polypropylene polymers can be prepared in the presence of Ziegler-Natta catalyst systems, based on organometallic compounds and on solids containing titanium trichloride.

Block copolymers can be manufactured similarly, except that propylene is generally initially polymerized by itself in a first stage and propylene and additional comonomers such as ethylene are then polymerized, in a second stage, in the presence of the polymer obtained during the first stage. Each of these stages can be carried out, for example, in suspension in a hydrocarbon diluent, in suspension in liquid propylene, or in gaseous phase, continuously or discontinuously, in the same reactor or in separate reactors.

When used herein, “polypropylene” refers to any of the polypropylene copolymers described above.

The compositions of any of the layers may include additives known in the art. The additives include plasticizers, processing aids, flow enhancing additives, flow reducing additives, lubricants, flame retardants, impact modifiers, nucleating agents to increase crystallinity, antiblocking agents such as silica, thermal stabilizers, UV absorbers, UV stabilizers, dispersants, surfactants, chelating agents, coupling agents, adhesives, primers and the like. One of ordinary skill in the art will recognize that additives may be added to the ionomer composition using techniques known in the art or variants thereof, and will know the proper amounts for addition based upon typical usage. The total amount of additives used in the composition may be up to about 5, 10 or 15 weight % based upon the weight of the ionomer composition. Notable additives include polycarbodiimides, which may protect the thermoplastics polyurethanes from hydrolysis.

The compositions described above can be formed or incorporated into generally planar multilayer films and sheets, or multilayer tubular films and pipes by methods known in the art. In general, sheets and pipes are thicker and stiffer than films and tubular films, respectively. The multilayer structures can be used as abrasion resistant liners or protective coverings.

Example multilayer structures may have three or more layers, in which the first surface layer comprises the soft thermoplastic composition, the second surface layer comprises a low melting soft ionomer, and at least one interior layer which may or may not comprise an ionomer. Additionally, the surface layers may have different thicknesses, depending on their function. For example, the first surface layer may be thicker and serves as an abrasion-resistant layer and the second surface layer may be thinner and serves as an adhesion layer to bond with the epoxy-coated substrate.

A multilayer liner of note comprises a first soft surface layer of the soft thermoplastic composition that is an abrasion resistant layer, a second surface layer of a low melting adhesive composition that may be adhered to metal or epoxy-primed metal, and at least one interior layer of a material selected from the group consisting of thermoplastic resin (including an additional ionomer layer different from the adhesive layer. The interior layer may provide bulk to the structure and/or may modify the properties of the structure, such as providing enhanced moisture barrier.

A notable multilayer structure comprises a first surface layer comprising the soft thermoplastic composition, an interior layer comprising an ionomer of an ethylene acid dipolymer, and a second surface layer comprising an ionomer of an ethylene acid terpolymer. A multilayer structure with ionomers in two adjacent categorical layers (such as adhesive and interior) does not require additional tie layers between the interior and adhesive layer, because the different ionomers adhere well to each other. For the same reason, a multilayer structure based on a low melting ethylene acid copolymer or terpolymer adhesive layer and an ionomer interior layer will not require tie layers.

The liner may be a complex multilayer structure of, in order, a first layer comprising the soft thermoplastic composition wear layer, a first tie layer, an interior layer of high density polyethylene (HDPE) or polypropylene (PP), a second tie layer and a second layer of terpolymer ionomer capable of bonding to the epoxy-primed steel. The tie layers bond the high density polyethylene (HDPE) or polypropylene (PP) to the ionomer layer. By adding a layer of HDPE or PP to the structure water permeation can be reduced in a much thinner liner structure. Materials suitable for optional tie layers (d) include maleated graft copolymers as described above.

An example multilayer structure comprises, in order, the first surface layer, an interior layer comprising high density polyethylene or polypropylene copolymer, a tie layer and the second surface layer comprising an ethylene acid terpolymer comprising an E/X/Y terpolymer wherein E represents copolymerized units of ethylene, X is present in an amount of about 2 to about 30 weight % of the E/X/Y polymer and represents copolymerized units of a C₃₋₈ α,β-ethylenically unsaturated carboxylic acid, and Y is present in from 3 to 45 weight % of the E/X/Y copolymer and represents copolymerized units of a softening comonomer selected from alkyl acrylate, alkyl methacrylate, wherein the alkyl groups have from 1 to 8 carbon atoms, or vinyl acetate; or an ionomer thereof wherein at least a portion of the carboxylic acid groups in the terpolymer are neutralized to salts containing alkali metal cations, alkaline earth metal cations, transition metal cations, or combinations of two or more of these metal cations.

Another example multilayer structure comprises, in order, the first surface layer, a tie layer, an interior layer comprising an ionomer of an E/W dipolymer, and the second surface layer comprising an ethylene acid terpolymer comprising an E/X/Y terpolymer wherein E represents copolymerized units of ethylene, X is present in an amount of about 2 to about 30 weight % of the E/X/Y polymer and represents copolymerized units of a C₃₋₈ α,β-ethylenically unsaturated carboxylic acid, and Y is present in from 3 to 45 weight % of the E/X/Y copolymer and represents copolymerized units of a softening comonomer selected from alkyl acrylate, alkyl methacrylate, wherein the alkyl groups have from 1 to 8 carbon atoms, or vinyl acetate; or an ionomer thereof wherein at least a portion of the carboxylic acid groups in the terpolymer are neutralized to salts containing alkali metal cations, alkaline earth metal cations, transition metal cations, or combinations of two or more of these metal cations.

A multilayer sheet may be produced by any method known in the art. Preferably the sheet is produced through melt processes, such as extrusion or coextrusion blown film processes, extrusion or coextrusion film or sheet melt casting processes, sheet profile extrusion or coextrusion processes, lamination processes, extrusion coating processes, calendar processes and the like. The films and sheets may undergo secondary formation processes, such as the plying together of preformed films or sheets to produce thicker sheets through thermal lamination.

Tubular films may be prepared by blown film extrusion or coextrusion. Alternatively, planar films and sheets may be formed into tubular articles by rolling widthwise to bring opposed ends of the sheet into contact, and bonding the edges together by processes including extrusion welding. The ends can be joined using either overlapping joints or butt joints.

Cast or blown films are typically up to 500 μm thick. Thicker structures may be described as sheets or tubes. Some protective applications may require protective layers 2000 to 3000 μm thick. If the wear layer is less than 0.04 inches thick (1 mm) the hardness of the supporting steel backing reduces the ability of the wear layer to behave elastically to the abrasive slurry and consequently the wear resistance of the liner deteriorates. Sheets may be from 3 to 60 mm thick. Thicker sheets provide more material for wear and reduce the permeation rate of water and chemicals through the liner so that interference with the bond between liner and prepared steel is minimized. In some cases, thick sheets or tubes may be built up by overlaying and adhering two or more thinner films.

As used herein, “overlaying” comprises placing layers of materials so that at least one layer is in contact with at least one other layer but is not bonded or adhesively attached to that other layer. Additional layers may be bonded or adhesively attached to the layers that are in contact but not bonded or adhesively attached.

A multilayer liner in the form of a tube comprises an innermost layer having a thickness of about 6.3 to about 51 mm (about 0.25 to about 2 inches) comprising a soft thermoplastic composition described above. The tube may have a hollow circular profile and the wall thickness may be uniform around the circumference of the tube, or the tube may have any profile and the wall thickness may vary around the circumference of the tube as desired, provided it is at least about 6.3 mm. The soft thermoplastic composition is positioned as the innermost layer to provide desirably superior abrasion resistance. The tube thickness provides not only a long lifetime under extreme abrasive use conditions, but also provides chemical resistance to protect the steel pipe from both abrasion and corrosion.

For hydroslurry transport of oil sands the liner is desirably from 0.7 to 1.5 inches thick (18 to 40 mm). The adhesive layer may be at least 0.05 inch (1.25 mm) thick or more. To provide adequate structure to the multilayer liner, the interior layer is desirably 30 to 50% of the overall thickness of the liner and the wear layer would be the balance, about 0.3 inches to about 1 inch (7.8 mm to 26.8 mm).

For transport of hydroslurries other than oil sands, where some wear resistance is required, the minimum liner thickness may be about 0.01 inch (2.5 mm). The liner may comprise about 1.25 mm of adhesive layer with the balance divided between interior layer and wear layer.

The multilayer tube may have any dimensions (including outside diameter, inside diameter and length) required to meet the end use needs. For example but not limitation the tube preferably has an outer diameter (OD) of about 2.54 to about 254 cm (about 1 to about 100 inches), more preferably about 25.4 to about 152 cm (about 10 to about 60 inches) and most preferably about 51 to about 102 cm (about 20 to about 40 inches). For example but not limitation the tube preferably has a length of about 1.5 to about 12.2 m (about 5 to about 40 feet), or about 3.1 to about 9.1 m (about 10 to about 30 feet) and or about 10 to about 30 m (about 30 to 100 feet) to provide a convenient length for storage, transport, handling and installation. Longer lined sections are preferred to minimize the number of joints that need to be made in the field.

The tubular liner may be produced by any suitable process. For example, the tube may be formed by melt coextrusion of a thick sheet that is subsequently rolled and seamed into a tube. In either the sheet or the tube cases layers of sheet or layers of tube may be plied together and then during the bonding of the plies into the epoxy primed pipe fuse together to develop strong thermal bonds to the epoxy primed steel as well as strong thermal bonds between adjacent plies. More detailed descriptions of such processes can be found in U.S. Patent Application Publication 2009/0107572.

The liner may be in the form of a multilayer tube comprising an outermost layer comprising an ionomer composition, an innermost layer comprising the soft thermoplastic composition, and an interior layer that comprises a thermoplastic material, including an ionomer with different composition than the outermost ionomer composition.

Copending application U.S. Patent Application Publication US2013/0065059A1 describes in greater detail metal substrates that can be lined with the abrasion resistant liner. Also as described in greater detail in US2013/0065059A1, it is desirable to use an epoxy coating on the surface of the metal to be protected by the abrasion resistant liner. To minimize the cost of epoxy coating the steel pipe it is desirable to use an epoxy that can be applied to the prepared steel pipe (sandblasted to white metal) at ambient temperature and that requires no preheating or post heating of the steel to achieve a hard durable surface finish. Since the ionomer liner is to be applied to the inside of steel pipes, it is important to develop a strong bond at the lowest possible interface temperature between epoxy and ionomer to prevent drooping or flow of the liner due to the pull of gravity. The epoxy primer desirably provides a strong thermally activated bond to the ionomer liner at an interface temperature between epoxy and ionomer that is higher than the melting point of the ionomer liner composition (about 90° C.), but less than a temperature at which the melt viscosity of the liner compositions are so low that they would start to flow.

A notable epoxy composition is SP-2888RG, an epoxy/urethane two part epoxy primer sold by Specialty Polymer Coatings, #101 20529 62nd Avenue, Langley BC V3A 8R4.

A notable base resin is EPON 828, an undiluted clear difunctional bisphenol A/epichlorohydrin derived liquid epoxy resin, sold by Hexion Specialty Chemicals, Inc. 180 East Broad Street, Columbus, Ohio 43215 (Hexion). This resin can be mixed with various chemical activators to provide various cure rates.

Methods for bonding the multilayer liner to metal substrates, including epoxy-coated substrates, are described in greater detail in copending U.S. Patent Application Publication US2013/0065059A1.

The liners described herein provide lined pipes with high abrasion-resistance and corrosion resistance for the conveyance of solids and slurries such as found in the agriculture, food and mining industries. The ionomer layer in the pipes provides very long lifetime, especially desirable for those industries that require long service lifetime due to the great maintenance and replacement complexity and cost. For example, oil slurry mining operations require kilometers of slurry pipelines in extreme environments, such as northern Alberta, Canada, so extended pipe lifetime is very desirable. Other mining operations that include the transport of highly abrasive particulate or slurry streams from the mine to processing refinery include, for example, iron ore, coal and coal dust, and the like, and in further non-mining transport processes, such as grain, sugar and the like.

### EXAMPLES

The following Examples are intended to be illustrative of the invention, and are not intended in any way to limit its scope.

Melt Index (MI) or Melt Flow Rate (MFR) was measured by ASTM D1238 at 190° C. using a 2.16 kg mass, unless indicated otherwise. A similar ISO test is ISO 1133. Shore D hardness was measured according to ASTM D2240 or ISO 868.

### Materials Used

ION-1: a poly(ethylene-co-n-butyl acrylate-co-methacrylic acid) containing 9 weight % methacrylic acid and 23.5 weight % n-butyl acrylate based on the total weight of the parent acid terpolymer, the carboxylic acid groups neutralized to about 51 mole % to salts of zinc ions, with an MI of about 0.6 to 0.8 g/10 min and a Shore D hardness of 40 and a Shore A of 84.

ION-2: a poly(ethylene-co-methacrylic acid) with 15 weight % methacrylic acid, the carboxylic acid groups neutralized to about 58 mole % to salts of zinc ions with MI of about 0.7 g/10 min and Shore D hardness of 64 and a shore A of 90.

Sample soft thermoplastic compositions for testing include the following.

Polypropylene thermoplastic vulcanizates
available from Exxon Mobil

| | | | Ultimate Tensile |
|---|---|---|---|
| | Grade | Shore A | Strength (MPa) |
| PP TPV 1 | Santoprene 191-85PA | 85 | 7.5 |
| PP TPV 2 | Santoprene 101-73 | 78 | 8.8 |
| PP TPV 3 | Santoprene 8201-90 | 96 | 13 |

Ethylene Copolymers available from DuPont

| | | | | | | Ultimate |
|---|---|---|---|---|---|---|
| | | | | | Flexural | Tensile |
| | | Density | MP | Shore | Modulus | Strength |
| | Comonomer | (g/cm³) | (° C.) | A | (MPa) | (MPa) |
| EMA | 35 weight % | | 77 | 73 | 4.3 | 4.7 |
| | methyl acrylate | | | | | |
| EVA1 | 40 weight % | 0.967 | 58 | 52 | | 10.2 |
| | vinyl acetate | | | | | |
| EVA2 | 40 weight % | 0.965 | 47 | 40 | | |
| | vinyl acetate | | | | | |

Thermoplastic urethanes available from Bayer Material Science

| | | | | | | Ultimate |
|---|---|---|---|---|---|---|
| | | | | | Flexural | Tensile |
| | | MP | Shore | Shore | Modulus | Strength |
| | Soft segment | (° C.) | D | A | (MPa) | (MPa) |
| TPU1 | polyether/polyester | 166 | | 77 | 19 | 15 |
| TPU2 | polyester | 149 | 32 | 85 | | 40 |
| TPU3 | aromatic polyether | 175 | 50 | | 103 | 41 |
| TPU4 | polyether | 180 | 50 | | 114 | 49 |

### NMR Analysis on Thermoplastic Urethane Polymer Samples

Nuclear magnetic resonance (NMR) was conducted on the thermoplastic urethane samples by dissolving them in N,N-dimethylformamide-d₇. The NMR spectra were collected on a 600 mHz spectrometer. The calculations per polymer segment were done as described in Brame, Edward, “Identification of Polyurethanes by high Resolution Nuclear Magnetic Resonance Spectrometry”, Analytical Chemistry Vol 39, No4 April 1967.

NMR Analysis for monomer estimation (mol %) on Thermoplastic Urethanes

| | polypropyl ether | PTMEG | adipate | propyl ester | BDO | MDI | total (mol %) |
|---|---|---|---|---|---|---|---|
| TPU-1 | 59.5 | | 10.1 | 3.0 | 17.5 | 10.0 | 100 |
| TPU-2 | | | 37.9 | | 49.6 | 12.5 | 100 |
| TPU-3 | | 64.9 | 0.0 | | 17.6 | 17.6 | 100 |
| TPU-4 | | 64.1 | 0.0 | | 18.0 | 17.8 | 100 |

PTMEG is poly tetramethylene glycol: molecular weight of PTMEG not estimated
Adipate is poly(ethylene adipate).. molecular weight of Adipate not estimated
Polypropyl ether: molecular weight of polypropy ether not estimated
Propyl ester: molecular weight of propyl ester not estimated
BDO is 1,4 butanediol
MDI is CAS Registry Number: 101-68-8 (4,4′methylene bis(phenyl isocyanate)

m-LLDPE ethylene butene copolymers available from Dow Chemical Company

| | grade | Density (g/cm³) | MP (° C.) | Shore D | Shore A | Ultimate Tensile Strength (MPa) |
|---|---|---|---|---|---|---|
| EB1 | ENR-7380 | 0.87 | 50 | 22 | 66 | 9.1 |
| EB2 | ENR-7270 | 0.88 | 64 | 29 | 84 | 13.0 |

HDPE: High Density Polyethylene with density of 0.962 g/cm³ and ultimate tensile strength of 42 MPa commercially available as Marflex 9659 from Chevron Phillips.
CLU: a crosslinked cast urethane (2 part urethane) shore A 75 available from Auto Add On, Kingston, ON.
Mild Steel used as a control on many of the wear measures refers to ASTM 1018 cold rolled steel.

The following additives commercially available from Dow Corning are blended with some of the materials listed above to prepare compositions for testing.

Additives

| | Description |
|---|---|
| MB25 | 25 weight % ultra high molecular weight siloxane |
| | dispersed in ION-2 |
| MB 50-002 | 50 weight % ultra high molecular weight siloxane |
| | dispersed in LDPE |
| MB50-010 | 50 weight % ultra high molecular weight siloxane |
| | dispersed in polyester elastomer |

Thickness and diameter in the following tables, unless specifically indicated, are in inches (1 inch=2.54 cm). “NM” stands for “not measured.”

In some cases test results on mixtures of wear polymers and additives are shown. These mixtures were prepared by drying the polymers and then, using a 25 mm 38/1 L/D ZSK-25 World Lab twin-screw extruder manufactured by Krupp Werner & Pfleiderer (W&P), melt blends were prepared, quenched and pelletized.

The dried thermoplastic or melt blends of thermoplastic polymers were then converted to test specimens by injection molding into 3.1 by 100 by 110 mm plaques using a Nissei 180-ton injection molding machine.

The crosslinked urethane (CLU) samples were prepared by casting the two part mixture into 3 mm thick and 6 mm thick, 150 mm by 150 mm molds. The urethane was allowed to cure and cool at ambient conditions.

### Test Methods and Results

Shore D and/or Shore A Hardness

These were either provided by the commercial supplier or determined according to ASTM D2240 “Standard Test Method for Rubber Property—Durometer Hardness” using at PTC Instruments model 307L. Measured values for Shore A are reported in Table 1.

### Abrasion Resistance Testing

Samples of various materials were tested for abrasion resistance according to the following Slurry Jet Erosion (SJE) test procedure.

The SJE test is generally used to evaluate the abrasion resistance performance of a material working in a slurry environment. The wear from a slurry jet is affected by many factors such as jet speed, distance, impingement angle, sand concentration and nature of the sand in the slurry. Since the size, form and hardness of the slurry particles may vary among applications, this test is often used for comparison and reference.

The test apparatus used consisted of a test chamber, connection pipes, a pump, a heater, a flow meter and a temperature controller.

Abrasion resistance was assessed according to the following procedure. Wear test coupons were cut from injection molded plaques of the materials.

Before and after the SJE test, the samples (2.5 by 2.5 by 0.31 cm) were conditioned in a vacuum oven for at least 15 hours until the moisture levels were constant and their weights measured with a precision balance (accuracy 0.1 mg).

The wear test coupons were then mounted in a test chamber and a 10 weight % aqueous sand (AFS50-70 test sand) slurry at room temperature (20 to 25° C.) was impinged on the wear test coupon through a slurry jet nozzle positioned 100 mm from its surface with a diameter of 4 mm at a slurry jet rate of 15-16 meters/second with a slurry jet angle of 90° relative to the surface plane for 2 hours. Weight loss was measured after a period of drying and then weight loss was converted to a volume loss based on wear layer density. Data are reported in Table 1.

TABLE 1

| Material | SJE mg/2 hr | Shore A |
|---|---|---|
| TPU-1 | 0 | 78 |
| EVA 1 | 0.1 | 58 |
| TPU-2 | 0.1 | 85 |
| EB 1 | 0.3 | 72 |
| PP TPV 1 | 0.6 | 85 |
| EB 2 | 1.7 | 84 |
| EVA 2 | 2.4 | 52 |
| PP TPV 2 | 3.5 | 80 |
| EMA | 4.5 | 73 |
| 50 weight % TPU-2/50 weight % TPU-3 | 5.7 | 89 |
| TPU-4 | 6.6 | 94 |
| PP TPV 3 | 6.7 | 87 |
| 50 weight % TPU-1/50 weight % TPU-3 | 7.6 | 89 |
| CLU | 9.6 | 82 |
| TPU 3 | 14.6 | 94 |
| ION 1 + 2 weight % MB25 | 15.5 | 90 |
| ION 1 | 16.9 | 85 |
| ION 1 + 4 weight % MB25 | 17.2 | 90 |
| ION 1 + 8 weight % MB25 | 19.1 | 91 |
| ION 1 + 4 weight % MB25 | 21.2 | 90 |
| ION 1 + 16 weight % MB25 | 23.4 | 90 |
| ION 1 + 4 weight % MB50-002 | 25.5 | 90 |
| ION 2 | 31.9 | 98 |
| 25 weight % ION 1/75 weight % PP TPV 2 | 32.4 | 85 |
| 50 weight % ION 1/50 weight % PP TPV 2 | 38.7 | 83 |
| HDPE | 38.2 | 98 |
| 25 ION-1/75% TPU-1 | 47.6 | 80 |
| HDPE + 2 weight % MB50-002 | 51.1 | 97 |
| 50 ION-1/50 TPU-1 | 58.3 | 80 |
| Mild Steel | 475.5 | |
| Mild Steel | 481.0 | |
| Mild Steel | 495.3 | |

Mild steel has a nominal density of 7.85 g/cm³ so the average mass loss of 484 mg/2 hr converts to a volume loss of 62 mm³/2 h. So in Table 1, all of the polymers (after correcting for density differences) have volume losses less than mild steel. For the hydroslurry application, there is an expectation that elastomer lined pipes would have wear rates substantially less than steel (<10 mm³/2 hr).

Soft homogenous polymers (Shore A less than 80) typically have less than 10 mg/2 hr of material wear on the SJE test. Reducing the hardness of the TPU's tends to reduce the material loss on the SJE test. TPU-3 with a nominal shore D 50 and a measured shore A of 94 had an SJE wear rate of 14.6 mg/2 hr. TPU-1 with a nominal shore A of 77 and a measured shore A of 78 had no measured material loss on the SJE test. Alloys or melt blends that do not behave like homogenous polymers may be soft but have high wear rates. For example ION-1 has an SJE of 16.9 mg/2 hr. TPU-1 has an SJE of 0 mg/2 hr. A melt blend of ION-1 and TPU-1 at either a 25%/75% or 50%/50% is 47.6 and 58.3 respectively so the performance is substantially inferior compared to either individual ingredient. However, preferred thermoplastics for the abrasion resistant layer have greater than 85 Shore A hardness so that they can withstand the abuse and handling during assembly without being scratched or indented which would lead to flow disruptions. In addition the abrasion resistant polymers desirably have melting points above 70° C. so that they have acceptable dimensional stability at the potential extreme operating conditions of the tailings line such as during clean-outs when a mixture of water and steam (no aggregate) may result in slurry temperatures approaching 70° C.

Adding surface modifying agents like the siloxane master-batches to the polymers (in a way that produces a molded part of consistent quality) typically only slightly increases the material loss on the SJE test.

### ASTM G-75: Determination of Slurry Abrasivity (Miller Number) and Standard Test Method for Determination of Slurry Abrasion Response of Materials (SAR Number).

We used this apparatus to monitor the mass loss in a 12.5 by 25 mm by 4.6 to 7 mm thick wear specimen after reciprocating in a AFS 50-70 sand water slurry (50 weight % sand) for six hours (mass loss was measured every two hours over the six hour test period). The standard test protocol refers to a neoprene lap but our testing found the neoprene lab tended to degrade during the testing of these softer wear materials and accumulate on the wear specimen. The neoprene lap was replaced with a 316 stainless steel lap. The wear results are reported in Table 2.

TABLE 2

Mass loss rate (mm³/6 hours)

| | coupon 1 | coupon 2 | average |
|---|---|---|---|
| TPU-3 | 4 | 6 | 5 |
| TPU-3 | 5 | 6 | 5 |
| TPU-2 | 5 | 7 | 6 |
| TPU-2 | 1 | 1 | 1 |
| EMA | 6 | 8 | 7 |
| TPU-4 | 11 | 9 | 10 |
| TPU-4 | 7 | 7 | 7 |
| TPU-1 | 7 | 13 | 10 |
| TPU-1 | 4 | 4 | 4 |
| CLU | 22 | 16 | 19 |
| ION-1 | 20 | 21 | 21 |
| ION -1 | 26 | 25 | 25 |
| Mild Steel¹ (neoprene lap) | 52 | 51 | 51 |
| Mild Steel | 196 | 183 | 190 |
| Mild Steel | 185 | 186 | 186 |
| ION 2 | 256 | 278 | 267 |
| HDPE | 1152 | 957 | 1055 |

¹There was a significant change in the material loss on the mild steel wear block when the lap material was changed from Neoprene (51 mm³/6 hr) to 316 stainless steel (186 to 190 mm³/6 hr).

On the G-75 wear test, low material loss is preferred. Because there is a certain amount of sample to sample variability, we considered the samples with wear rates less than 20 mm³/6 hours to be samples with very good resistance to slurry wear. Samples with wear rates between 20 and 200 mm³/6 hours were considered to be moderately slurry wear resistant materials and samples with wear rates greater than 200 mm³/6 hours were considered to be poor slurry resistant materials. Based on the G-75 testing, the TPU's were promising wear materials for the multilayer protective liner.

### D4060 Taber Abrasion

This was assessed using a CS-17 wheel with 1000 g load, and material loss in mg is reported after 1000 cycles. Harder Materials typically have better Taber abrasion resistance. To avoid fouling of the wheels or test sample, the test was stopped and the apparatus and sample surface cleaned at intervals of 50 cycles. Table 3 reports the mass and calculated volume loss (based on nominal density) of mild steel and various polymers and blends of polymers.

TABLE 3

| Material | mg | mm³ |
|---|---|---|
| TPU-4 | 0 | 0 |
| TPU-1 | 0 | 0 |
| TPU-2 | 0 | 0 |
| TPU-3 | 0 | 0 |
| Mild Steel | 79 | 10 |
| Mild Steel | 79 | 10 |
| HDPE | 10 | 10 |
| ION-1 + 4 weight % MB50-002 | 19 | 21 |
| ION-1 + 8 weight % MB25 | 22 | 24 |
| ION-1 + 4 weight % MB25 | 22 | 24 |
| EVA 2 | 25 | 26 |
| ION-2 | 29 | 30 |
| ION-1 + 4 weight % MB25 | 29 | 31 |
| ION-1 + 2 weight % MB25 | 39 | 41 |
| EMA | 42 | 44 |
| ION-1 | 42 | 44 |

In Table 3, the mass loss of mild steel after 1000 cycles was 79 mg. Using a density of 7.85 g/cm³ for mild steel, the 79 mg of mass loss converts to a volume loss of 10 mm³. Using mild steel as a benchmark, all four grades of TPU's had less volume loss relative to the steel. Similarly, combinations of ION-1 and a surface modifying agent also had volume losses similar to mild steel. High density polyethylene, with a density of 0.962, lost 10 mm³ of material on Taber Abrasion. The EMA polymer with a shore A hardness of 77 had relatively high material loss on Taber abrasion of 44 mm³.

As mentioned on the discussion of the SJE results, the parts molded from the melt blends of two polymers need to behave homogeneously.

We have presented data that ranks the various polymers based on three types of abrasion (SJE, G-75 and taber). Considering these tests, a moderately hard TPU like TPU-4 scored well on all of the measures. TPU-4 had a SJE wear rate of 6.6 mg/2 hr which is still very low wear compared to the steel control sample. It was in the group of best performing materials in the G75 abrasion test, and the Taber abrasion test.

Thermoplastic urethanes can undergo hydrolysis that can cause a loss in molecular weight, mechanical properties and presumably resistance to wear. Methods to improve a polymer's resistance to hydrolysis include selection of comonomers (ether-based soft segments are preferred over ester-based soft segments), adding stabilizers that protect the polymers from hydrolysis and increasing the molecular weight of the polymer.

To characterize the sensitivity of the various potential wear candidates to hydrolysis, tensile properties as per ASTM D638 were measured on “type 4” tensile bars after zero, two, four and six weeks, and 6 and 11 months of conditioning in water at 75° C. (50 mm/min XHS, 50 mm jaw separation).

TABLE 4

| | elongation at break | | | | | |
|---|---|---|---|---|---|---|
| grade | 0 week | 2 weeks | 4 weeks | 6 weeks | 6 months | 11 months |
| EMA | 843 | 959 | 1033 | 959 | 804 | 965 |
| TPU-2 | 608 | 576 | 790 | 23 | 0 | 0 |
| ION-1 | 227 | 454 | 463 | 350 | 400 | 92 |
| ION-2 | 69 | 75 | 91 | 84 | 35 | 15 |
| TPU-3 | 655 | 696 | 707 | 709 | 651 | 591 |
| CLU | | | | | 268 | 103 |
| TPU-1 | 1010 | 1205 | 1151 | 1157 | 26 | 30 |
| HDPE | 1260 | 1239 | 800 | 800 | 1194 | 813 |
| TPU-4 | 517 | | | | 689 | 687 |
| | | | | | (4.5 | (9.5 |
| | | | | | months) | months) |

The data in Table 4 suggest all of the materials have relatively good retention of tensile properties after 6 weeks of water exposure at 75° C. For the purpose of assessing performance in the water exposure test, the time to observe a loss of 50% of the initial elongation was considered the time to failure. It took just 6 weeks of immersion in 75° C. water for the TPU-2 sample to lose over 50% of its initial elongation. From this it was concluded that a TPU comprising adipate and propyl ester soft segments had the least resistance to this 75° C. water immersion condition. Substituting most of the ester soft segments for polypropyl ether soft segments, improved the resistance of TPU-1 to 4 and 6 weeks of 75° C. water exposure, but after 6 months of this water exposure condition TPU-1, which still contained a minor amount of ester soft segments had lost over 50% of its initial elongation. TPU-3 and TPU-4 which contained only PTMEG as the soft segment based on elongation retention, were unaffected by 11 and 9.5 months (respectively) of water immersion at 75° C.

The wear layer is just one component of the elastomer lined steel pipe. The lining must also adhere strongly to the steel wall and provide chemical resistance to prevent chemical attack at the steel/liner interface that would otherwise weaken the bond between liner and steel. As described in copending U.S. Patent Application Publications US2013/0065059A1 and US2013/0065000A1, ionomer adhesive layers and ionomer core layers provide the necessary strong bond to the steel and the necessary chemical resistance but it is desirable to identify coextrudable tie layer compositions that will produce strong bonds between the various layers in the pipe liner.

### D 1876 Thermal Bond Strength

Bond strength was assessed by a 90° t-peel at 10 inch/min crosshead speed in lbf/inch) to the ter-ionomer or other adhesive layer. The thermal laminates were prepared from 3 mm thick by 100 mm by 115 mm injection molded plaques. The two layers were thermally laminated on a Carver press with a 150° C. top and bottom platen set-point temperature. Plaques were bonded using a 5 minute bonding time. Five 12 mm wide by 115 mm long coupons were die cut from the two layer thermal laminates for the t-peel. The reported bond strength is the average of five test coupons.

Table 5 summarizes preliminary t-peel results to identify preferred tie layer materials to bond TPU wear layer to the ionomer core. The various materials were bonded to a layer of TPU-4 and ION 2 at 150° C. bond temperature.

TABLE 5

Bond Strength (N/25 mm)

| Tie Layer Material | t-peel to TPU-4 | t-peel to ION-2 |
|---|---|---|
| EAC-1 | 53 | 480 |
| EAC-2 | 62 | 427 |
| EAC-3 | 62 | 383 |
| maEVA-1 | 231 | 107 |
| maEVA-1 | 160 | 53 |
| maEVA-2 | 160 | 36 |
| maEMA-1 | 160 | 62 |
| maLLDPE-1 | 62 | 0 |
| maLLDPE-2 | 27 | 9 |
| maEE-1 | 116 | 9 |

EAC-1: poly(ethylene-co-methacrylic acid) with 15 weight % methacrylic acid, with MI of about 25 g/10 min.
EAC-2: poly(ethylene-co-acrylic acid) containing 9 weight % acrylic acid with an MI of about 10 g/10 min.
EAC-3: poly(ethylene-co-n-butylacrylate-co-methacrylic acid) containing 10 weight % nbutylacrylate and 10 weight % methacrylic acid based on the total weight of the parent acid terpolymer, with MI of about 10 g/10 min.
maEVA-1: anhydride-modified ethylene vinyl acetate polymer with a Vicat softening point as measured by ASTM D1525 of 42 and an MI of 10.9.
maEVA-2: anhydride-modified ethylene vinyl acetate polymer with a Vicat softening points as measured by ASTM D1525 of 47° C. and an MI of 4.5
maEMA-1: anhydride modified ethylene acrylate resin with a Vicat softening point of 50° C. and an MI of 7.7.
maLLDPE-1: anhydride-modified, linear low-density polyethylene (LLDPE) with Vicat softening of 103° C. and an MI of 2.7
maLLDPE-2: maleic anhydride modified metallocene lldpe (ethylene-octene) polyethylene graft copolymer, with MI of about 1.6 g/10 min. and melting point of 50° C.
maEE-1: maleic anhydride modified ethylene elastomer graft copolymer, with melt flow rate of about 23 g/10 min., measured at 280° C. using a 2.16 kg mass

The t-peel results reported in Table 5 represent the average of five 90° t-peels at a cross-head speed of 10 inches/min. In each of the five tests, the average peel force over the cross-head displacement of 2.5 cm to 12.5 cm of cross-head displacement was measured. This section of cross-head travel excludes the relatively higher value of peel force required to initiate a peel. The table below illustrates the difference between the average peel force and the maximum peel force for the t-peel between EAC-3 and TPU-4. The maximum peel force is about 16% higher than the average.

TABLE 6

| | | Average | Ave Load | | |
|---|---|---|---|---|---|
| | | Load | Between | Maximum | |
| | Maximum | Between | limits/Width | Load/Width | Width |
| Sample | Load (N) | limits (N) | (N/25 mm) | (N/25 mm) | (mm) |
| 1 | 36.7 | 32.7 | 65 | 73 | 12.7 |
| 2 | 35.8 | 33.1 | 66 | 72 | 12.7 |
| 3 | 35.5 | 32.4 | 65 | 71 | 12.7 |
| 4 | 35.6 | 27.7 | 55 | 71 | 12.7 |
| 5 | 36.2 | 29.9 | 60 | 72 | 12.7 |
| Mean | 36 | 31 | 62 | 72 | 13 |

Table 5 indicates co-extrudable tie layer materials like maEVA-1 or maEVA-2 (which are both anhydride-modified ethylene vinyl acetate polymers with Vicat softening points as measured by ASTM D1525 of 42 and 47° C. respectively) or maEMA-1 (an anhydride modified ethylene acrylate resin with a Vicat softening point of 50° C.), provide strong thermally activated bonds to TPU-4. Similarly, maLLDPE-1, an anhydride-modified, linear low-density polyethylene (LLDPE) with Vicat softening of 103° C.) also gives a strong thermal bond to TPU-4. A chemically modified ethylene elastomer, maEE-1, also produced a strong bond to TPU-4. The polyethylene methacrylic acid copolymers like EAC-1 and EAC-2, and polyethylene methacrylic acid, n butyl acrylate terpolymers like EAC-3 produced strong bonds to ION-2 but relatively inferior bonds to TPU-4. Of the various tie layer materials tested, maEVA-1 appeared to give the best balance of adhesion to both the TPU and the ionomer. To determine the efficacy of the interlayer bond for the slurry liner application, Atlas Cell testing (ASTM C868-02 (2008)) of coextruded or thermally laminated liners bonded to epoxy primed steel plates was undertaken. The inside of the cell was filled with water at 55° C. and the outside of the cell was at ambient temperature 20±2° C. After one month of Atlas cell service a 3 mm thick D-E-B co-extrusion wherein the D layer was TPU-4, The E layer was maEVA-2 and the B layer was ION-2 started to blister at the interface between the D and the B layers. That suggests that the bond strength (approximately 36 N/25 mm) between the maEVA-2 and the ionomer layer was insufficient for the Atlas cell (where ideally blistering would not occur even after months of exposure).

A better tie layer material to bond ionomer to TPU was required. It was found a blend comprising an anhydride functionalized EVA with a vicat softening point of 42° C. (maEVA-1) and EAC-3, an acid modified ethylene acrylate terpolymer resin with a vicat softening point of 60° C. provided improved adhesive properties compared to just an anhydride functionalized EVA.

TABLE 7

| | | tie layer blends | | | | | |
|---|---|---|---|---|---|---|---|
| | | 1 | 2 | 3 | 4 | 5 | 6 |
| | | weight | weight | weight | weight | weight | weight |
| | | % | % | % | % | % | % |
| maEVA-1 | | 50 | 55 | 60 | 65 | 70 | 75 |
| EAC-3 | | 50 | 45 | 40 | 35 | 30 | 25 |
| maEVA-1/EAC-3 | | 50/50 | 55/45 | 60/40 | 65/35 | 70/30 | 75/25 |
| Average Peel Strength | N/25 mm | 107 | 156 | 207 | 147 | 43 | 202 |
| to TPU (TPU-4) | | | | | | | |
| Average Peel Stength | N/25 mm | 241 | 219 | 230 | 127 | 140 | 96 |
| to Ionomer (ION 2) | | | | | | | |

The preferred ingredient blend was 60 weight % anhydride modified EVA with 40 weight % acid modified ethylene acrylate terpolymer. This ratio gave the adhesive best balance of peel strength to both TPU and Ionomer.

Thermoplastic urethanes with shore D values around 50 consisting essentially of all PTMEG soft segments performed well on all the test measures. TPU-4 with a nominal 50 shore D scored consistently high in all of the tests.

An example tubular liner has a three layer construction comprising an adhesive layer comprising ION-1, a core layer comprising ION-2 and an innermost layer comprising the sample wear layer. For a 0.4 inch (10 mm) thickness of the example liner 5 to 10% (0.5 to 1 mm) of the overall structure would be adhesive, 25 to 50% (2.5 to 5 mm) of the overall structure would be core and 40 to 70% (4 to 7 mm) of the overall structure would be wear. The three layer structure assumes the wear layer forms a strong bond to the core layer.

A second type of example liner is a four layer construction comprising an adhesive layer comprising ION-1, a core layer comprising ION-2, a coextrudable tie layer comprising a blend of anhydride modified EVA and acid modified ethylene acrylate terpolymer and an innermost layer comprising the sample wear layer. For a 0.4 inch (10 mm) thickness of the example liner 5 to 10% (0.5 to 1 mm) of the overall structure would be adhesive, 25 to 50% (2.5 to 5 mm) of the overall structure would be core, 5 to 10% (0.5 to 1 mm) of the overall structure would be coextrudable tie layer and 30 to 65% would be interior wear layer.

Methods for fabricating three- or four-layer liners are described in greater detail in copending U.S. Patent Application Publications US2013/0065059A1 and US2013/0065000A1. Those procedures can be adapted to prepare the liners described herein by substitution of the instant wear layer (thermoplastic urethanes) for the ionomer wear layer described therein.

1. A thermoplastic multilayer structure comprising at least three layers wherein
(a) a first surface layer acts comprises a soft thermoplastic polyether based urethane composition with melting point in a range from about 120 to about 220° C., Shore A hardness (ASTM D2240, ISO 868) from 85 to 95, and Shore D hardness from 32 to 50; optionally blended with a surface modifying agent;
(b) a second surface layer comprises a thermoplastic ethylene acid copolymer composition, or an ionomer thereof, with melting point in a range from about 60 to about 100° C.;
(c) at least one tie layer positioned in contact with one of the surface layers and in contact with one other layer, comprising a coextrudable tie layer composition comprising a polyolefin graft copolymer comprising a trunk polymer comprising polyethylene, polypropylene, styrene-ethylene-butene-styrene triblock copolymer, polybutadiene or a copolymer comprising copolymerized units of ethylene and copolymerized units of vinyl acetate, alkyl acrylate or alkyl methacrylate wherein the alkyl groups have from 1 to 8 carbon atoms, wherein the trunk polymer is modified by grafting thereto a cyclic anhydride of C₄-C₈ unsaturated acids; and optionally
(d) an interior layer of a material comprising a thermoplastic composition with melting point in a range from about 75 to about 150° C., and moisture vapor permeation value less than 2 g-mil/100 in²-day.

2. The multilayer structure of claim 1 wherein the second surface layer comprises an ethylene acid terpolymer comprising an E/X/Y terpolymer wherein E represents copolymerized units of ethylene, X is present in an amount of about 2 to about 30 weight % of the E/X/Y polymer and represents copolymerized units of a C₃₋₈ α,β-ethylenically unsaturated carboxylic acid, and Y is present in from 3 to 45 weight % of the E/X/Y copolymer and represents copolymerized units of a softening comonomer selected from alkyl acrylate, alkyl methacrylate, wherein the alkyl groups have from 1 to 8 carbon atoms, or vinyl acetate; or an ionomer thereof wherein at least a portion of the carboxylic acid groups in the terpolymer are neutralized to salts containing alkali metal cations, alkaline earth metal cations, transition metal cations, or combinations of two or more of these metal cations.

3. The multilayer structure of claim 2 wherein X is methacrylic acid, present in an amount from 5 to 20 weight % of the E/X/Y terpolymer and Y is butyl acrylate, present in an amount from 10 to 30 weight % of the E/X/Y terpolymer.

4. The multilayer structure of claim 3 wherein the second surface layer comprises the E/X/Y terpolymer.

5. The multilayer structure of claim 3 wherein the second surface layer comprises an ionomer of the E/X/Y terpolymer.

6. The multilayer structure of claim 1 wherein the interior layer comprises
(1) an ionomer of an E/W ethylene acid dipolymer wherein E represents copolymerized units of ethylene, W is present in an amount of about 2 to about 30 weight % of the E/W polymer and represents copolymerized units of a C₃₋₈ α,β-ethylenically unsaturated carboxylic acid, wherein at least a portion of the carboxylic acid groups in the dipolymer are neutralized to salts containing alkali metal cations, alkaline earth metal cations, transition metal cations, or combinations of two or more of these metal cations; or
(2) a polyethylene homopolymer, polyethylene copolymer, or polypropylene copolymer.

7. The multilayer structure of claim 6 wherein the second surface layer comprises an ethylene acid terpolymer comprising an E/X/Y terpolymer wherein E represents copolymerized units of ethylene, X is present in an amount of about 2 to about 30 weight % of the E/X/Y polymer and represents copolymerized units of a C₃₋₈ α,β-ethylenically unsaturated carboxylic acid, and Y is present in from 3 to 45 weight % of the E/X/Y copolymer and represents copolymerized units of a softening comonomer selected from alkyl acrylate, alkyl methacrylate, wherein the alkyl groups have from 1 to 8 carbon atoms, or vinyl acetate; or an ionomer thereof wherein at least a portion of the carboxylic acid groups in the terpolymer are neutralized to salts containing alkali metal cations, alkaline earth metal cations, transition metal cations, or combinations of two or more of these metal cations.

8. The multilayer structure of claim 7 wherein X is methacrylic acid, present in an amount from 5 to 20 weight % of the E/X/Y terpolymer and Y is butyl acrylate, present in an amount from 10 to 30 weight % of the E/X/Y terpolymer.

9. The multilayer structure of claim 8 wherein the second surface layer comprises the E/X/Y terpolymer.

10. The multilayer structure of claim 8 wherein the second surface layer comprises an ionomer of the E/X/Y terpolymer.

11. The multilayer structure of claim 1 wherein the tie layer comprises a blend of polyolefin graft copolymer and a terpolymer comprising copolymerized units of ethylene, acrylic acid or methacrylic acid, and an alkyl acrylate or alkyl methacrylate, wherein the alkyl group comprises 1 to 4 carbon atoms.

12. The multilayer structure of claim 11 wherein the polyolefin graft copolymer comprises a trunk polymer comprising copolymerized units of ethylene and copolymerized units of vinyl acetate, alkyl acrylate or alkyl methacrylate; wherein the alkyl groups have from 1 to 8 carbon atoms, wherein the trunk polymer is modified by grafting thereto maleic anhydride and the terpolymer comprises copolymerized units of ethylene, methacrylic acid, and butyl acrylate.

13. The multilayer structure of claim 6 wherein the interior layer comprises a polyethylene homopolymer, polyethylene copolymer, or polypropylene copolymer.

14. The multilayer structure of claim 13 comprising, in order, the first surface layer, a first tie layer, the interior layer comprising high density polyethylene or polypropylene copolymer, a second tie layer and the second surface layer comprises an ethylene acid terpolymer comprising an E/X/Y terpolymer wherein E represents copolymerized units of ethylene, X is present in an amount of about 2 to about 30 weight % of the E/X/Y polymer and represents copolymerized units of a C₃₋₈ α,β-ethylenically unsaturated carboxylic acid, and Y is present in from 3 to 45 weight % of the E/X/Y copolymer and represents copolymerized units of a softening comonomer selected from alkyl acrylate, alkyl methacrylate, wherein the alkyl groups have from 1 to 8 carbon atoms, or vinyl acetate; or an ionomer thereof wherein at least a portion of the carboxylic acid groups in the terpolymer are neutralized to salts containing alkali metal cations, alkaline earth metal cations, transition metal cations, or combinations of two or more of these metal cations, wherein the compositions of the first and second tie layers may be the same or different.

15. The multilayer structure of claim 14 wherein X is methacrylic acid, present in an amount from 5 to 20 weight % of the E/X/Y terpolymer and Y is butyl acrylate, present in an amount from 10 to 30 weight % of the E/X/Y terpolymer.

16. The multilayer structure of claim 15 wherein the second surface layer comprises the E/X/Y terpolymer.

17. The multilayer structure of claim 15 wherein the second surface layer comprises an ionomer of the E/X/Y terpolymer.

18. The multilayer structure of claim 1 that is in the form of a generally planar multilayer sheet, or multilayer tubular pipe liner.

19. The multilayer structure of claim 1 that is adhered to the inside of a metal pipe.

20. A method for protecting a metal pipe from abrasion during transport of a slurry comprising liquid and abrasive material through the pipe, the method comprising
(a) preparing a multilayer structure according to claim 1;
(b) inserting the multilayer structure inside a pipe;
(c) adhering the multilayer structure to the inside of the pipe to prepare a lined pipe;
(d) installing the lined pipe into a pipeline for transporting a slurry comprising liquid and abrasive material; and
(e) transporting the slurry through the pipeline.

21. The method of claim 20 wherein the second surface layer comprises an ethylene acid terpolymer comprising an E/X/Y terpolymer wherein E represents copolymerized units of ethylene, X is present in an amount of about 2 to about 30 weight % of the E/X/Y polymer and represents copolymerized units of a C₃₋₈ α,β-ethylenically unsaturated carboxylic acid, and Y is present in from 3 to 45 weight % of the E/X/Y copolymer and represents copolymerized units of a softening comonomer selected from alkyl acrylate, alkyl methacrylate, wherein the alkyl groups have from 1 to 8 carbon atoms, or vinyl acetate; or an ionomer thereof wherein at least a portion of the carboxylic acid groups in the terpolymer are neutralized to salts containing alkali metal cations, alkaline earth metal cations, transition metal cations, or combinations of two or more of these metal cations.

22. The method of claim 21 wherein the second surface layer comprises an ionomer of the E/X/Y terpolymer, X is methacrylic acid, present in an amount from 5 to 20 weight % of the E/X/Y terpolymer and Y is butyl acrylate, present in an amount from 10 to 30 weight % of the E/X/Y terpolymer.

23. The method of claim 21 wherein the interior layer comprises
(1) an ionomer of an E/W ethylene acid dipolymer wherein E represents copolymerized units of ethylene, W is present in an amount of about 2 to about 30 weight % of the E/W polymer and represents copolymerized units of a C₃₋₈ α,β-ethylenically unsaturated carboxylic acid, wherein at least a portion of the carboxylic acid groups in the dipolymer are neutralized to salts containing alkali metal cations, alkaline earth metal cations, transition metal cations, or combinations of two or more of these metal cations; or
(2) a polyethylene homopolymer, polyethylene copolymer, or polypropylene copolymer.

24. The method of claim 20 wherein the inside of the metal pipe is treated with an epoxy primer to provide an epoxy-primed metal pipe prior to inserting the multilayer structure into the pipe.

25. The method of claim 25 wherein adhering the multilayer structure to the inside of the pipe comprises heating the liner to metal interface by applying heat to the exterior of the metal pipe at a temperature less than 160° C. while applying pressure to the inside of the liner to expand the liner so that it comes into intimate contact with the interior inside surface of the epoxy-primed metal pipe and subsequently thermally activates the bond between liner and metal substrate.
